(19) United States
(12) Patent Application Publication
(10) Pub. No.: US 2004/0049627 A1
(43) Pub. Date: Mar. 11, 2004

(54) Method and system for controlling compact flash memory

(75) Inventors: Fong Piau, Jalan Macalister (MY); Ong Chun Huat, Jalan Macalister (MY)

Correspondence Address: PENINSULA IP GROUP, 2290 North First Street, Suite 101, San Jose, CA, 95131, US

(73) Assignee: Flex-P Industries

(21) Appl. No.: 10/053,496

(22) Filed: Nov. 9, 2001

(51) Int. Cl. G06F 12/00

(52) U.S. Cl. 711/103; 711/170

(57) ABSTRACT

Disclosed herein is a flash memory controller that is incorporated in a flash memory. The flash memory controller allows the memory card to operate in either the PCMCIA mode, or true IDE mode. The method and system for the controller is adapted to selectively recall the data from the flash memory and transmit the data to one or more recipient devices via the PCMCIA type interface, or the true IDE interface, or by an alternate interface. The method and system, when manipulated by the host device, induces the controller to send the data via the PCMCIA type interface, or the true IDE interface. In another embodiment, an alternate allows data stored in the flash memory to be transmitted via a number of specified input devices.

### BACKGROUND OF THE INVENTION

1. Field of the Invention

The present invention is generally related to flash memory systems. More particularly, the invention relates to a compact flash controller that manages a set of compact flash memory modules used as a storage device, and/or an external memory device having a flash memory as a storage medium.

2. Description of the Related Art

Many of the smaller electronic devices and systems such as digital cameras, MPEG portable music system, and personal data assistants are now being configured with memory designed to store both data and applications content captured by these devices. One advantage of having memory in such devices is that the captured data or application content can be eventually downloaded to a host system at a subsequent time. For example, a digital camera captures an array of images and stores them in memory to be downloaded to an image or graphics application program running on a computer system that coverts the captured images into high-resolution photographs that can be incorporated in newspaper and magazine articles or a presentation.

Typically, these devices employ a non-volatile, readable/writable storage device that requires very little, if any, power to retain its content. This solid state or semiconductor data storage system, commonly referred as a flash memory is a card that incorporates a controller, plurality of flash memory modules or arrays, and a PCMCIA interface that provides the required connectivity to an electronic device or system. Each module includes a number of flash memory cells that are organized in a set of independently erasable blocks. The controller performs the fundamental operation of read, write, and block erase to stores either data or application content in one or more memory locations and then recalls the stored data or application content, upon request, for output to an external device or system. Unlike other forms of memory or mass storage, the amount of time necessary to perform a write data or program bit and erase can be significant. Nevertheless, for a number of applications, the advantages of low power, ruggedness, portability and smaller size of a flash memory system makes it a reasonable alternative to other data storage devices.

FIG. 1 is a block diagram illustrating a typical flash memory controller as implemented in the prior art. FIG. 1 shows that the flash memory controller 104 comprises a host interface 110 that includes a host multiplexer 116, a buffer manager 112 that has a buffer multiplexer 118, and a flash memory formatter 114 comprising a flash memory sequencer 120 and an ECC process circuit 122 to perform error correction. The host interface 110 transfers data, commands and or application content to and from the host computer 102. The host multiplexer 116 operates on time division basis to convert the received data, commands or application content in a sixteen bit format into an eight bit format prior to it being stored in one or more flash memory arrays 108. In addition, the host multiplexer 116 converts the data, commands or application content retrieved from flash memory 108 into a sixteen bit data stream so it can be transmitted back to the host computer 102 for processing.

As shown by FIG. 1, the flash memory controller 104 uses an external buffer 106 to execute all of the read/write operations between the host system 102 and the flash memory 108. Thus, when data is to be written to flash memory 108, the data, commands or application content received from the host computer 102 is converted from a sixteen bit to a eight bit data stream by the host interface 110 and is then placed in the external data buffer 106 by the buffer memory manager 112. Once stored in the buffer 106, the data is directed through the buffer memory multiplexer 118 of the buffer manager 112 to the flash memory formatter 114. The flash memory sequencer 120 controls an access process of writing to and or reading from one or more sectors of the flash memory 108. Under program control, the flash memory sequencer 120 transfers data or application content, via an eight-bit bus, to and from one or more sectors of the flash memory 108. As described above, all data movement or transfer functions between the host system 102 and the flash memory 108 must pass through the buffer multiplexer 118 and external buffer 106. This is due to the fact that the transfer rate of flash memory 108 is much slower than that of host computer 102. In other words, in order to perform either a write to, read from, or erase the contents function, the eight bit

[symbol]

An object of the present invention is to provide a new and improved compact flash memory controller by overcoming at least some of the disadvantages and limitations of flash memory controller as implemented in the prior art.

It is also an object of the present invention to provide a compact flash controller that provides a means for writing to and reading data from a plurality of flash memory modules with improved throughput characteristics.

The above and other objects are attained by a compact flash memory controller in accordance with this invention controlling the data transfer procedures between flash memory and a host device performed by a compact flash controller comprising the steps of inserting and powering up a compact flash memory device containing a plurality of compact flash memory arrays; detecting presence of a plurality of compact flash memory arrays wherein the compact flash controller detects the number of compact flash memory arrays that comprise the compact flash memory device; initializing controller, a plurality of flash memory modules as well as other internal components; partitioning each of the flash memory arrays in accordance to the parameters of the configuration information table stored in a read-only memory of the compact flash controller; determining which interface specification is to be used for to transfer data, address information and control signals to and from the host device; detecting a command sequence to be processed; translating the specified command sequence into a set of data transfer operative elements; and executing the specified data transfer.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a block diagram illustrating a typical flash memory controller as implemented in the prior art.

FIG. 2 is a block diagram illustrating the operative components of a compact flash controller in accordance with the present invention.

FIGS. 3a-3i are exemplary flow charts illustrating the flow of events performed by the compact flash controller to detect, initialize, and configure one or more installed flash memory modules in accordance with FIG. 2.

FIGS. 4a an 4b is a detailed flow of event preformed by the compact flash controller to execute the fundamental commands of transferring data or applications content in or out of flash memory.

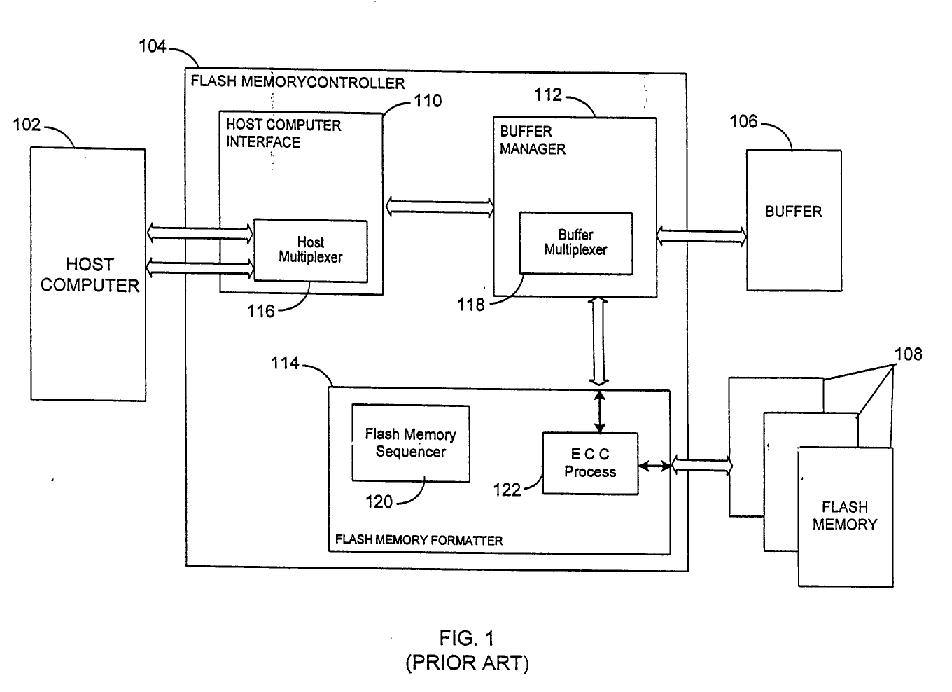

### DETAILED DESCRIPTION OF THE INVENTION

The present invention now will be described more fully with reference to the accompanying drawings, in which the preferred embodiments of the invention are shown. The present invention may, however, embodied in many different forms and should not be construed as limited to the embodiment set forth herein; rather these embodiments are provided so that this disclosure will be thorough and complete and will fully convey the invention to those skilled in the art.

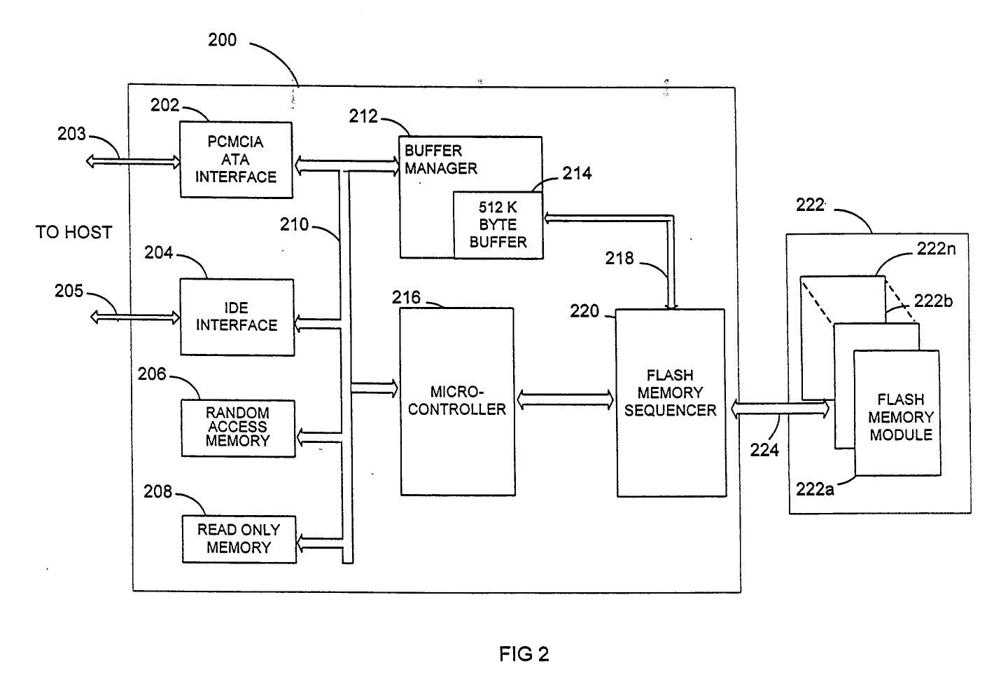

The invention will now be described with respect to FIG. 2, which illustrates the operative components of a compact flash controller 200 in accordance with the present invention. FIG. 2 shows flash memory 222 consisting of a plurality of NAND type flash memory modules 222a-222n is connected, via data bus 224, to compact flash controller 200 that manages all of the data transfer operation in and out of flash memory 222. For purposes of this embodiment, compact flash memory controller 200 specifically directs data to be stored to a pair of flash memory modules 222a and 222b. Flash memory module 222a store the odd data segment of a received data word while flash memory module 222b stores the remaining even bit data segment of the data word. Thus, a data word received from a host device is parsed into an odd data segment that is written to and stored in flash memory modules 222a and an even data segment is written to and stored in flash memory module 222b.

As FIG. 2 shows the compact flash controller 200 includes a PCMCIA-ATA interface 202, an IDE interface 204, random access memory 206, ROM memory 208 used for program storage, a buffer manager 212 and a microcontroller 216 that are interfaced to a high-speed data bus 210. Here, either the PCMCIA-ATA interface 202 or the IDE Interface can transmit to or receive data, addresses and an array of control signals from a host or external device through either bidirectional data interface 203 or 205, respectfully. For the purposes of this embodiment, data received from the host device is then transferred by the PCMCIA-ATA interface 202 across high-speed bus 210 to be stored in the buffer 214 of buffer manager 212. Once the data word received from the PCMCIA-ATA interface 202, it is parsed into an even data segment and an odd segment that is temporarily stored in the buffer 214 of the buffer manager 212.

FIG. 2 also shows that the buffer manager 212 is directly connected via a separate data interface 218 to a flash memory sequencer 220. Under program control, the microcontroller 216 directs the buffer manager 212 to sequentially move both the each data segment or sector stored in buffer 214 through a FIFO like data register (first-in/first-out) of the buffer manager and buffer 212 and across the attached data interface 218 to the flash memory sequencer 220. Upon receipt of the two data strings by flash memory sequencer 220, an ECC error correction procedure is performed prior to being processed and written to flash memory 222. This allows errors that would normally cause a problem, to be detected and corrected without effecting the operation of the system. Once the ECC error correction process is complete, the flash memory sequencer 220 then transfers the both odd and even data segments as well as the associated error correction code via a flash memory data interface 224 to flash memory module 222a and flash memory module 222b, respectfully.

When data is read from flash memory 222, the requested odd and even data segments are transferred from flash memory module 222a and flash memory module 222b, respectfully across the flash memory data interface 224 to the flash memory sequencer 220. The data segments are then moved to the buffer 214 of the buffer manager and 212 where they are concatenated into a complete data word that can be transferred back to the host either through the PCMCIA-ATA interface 203 or the IDE Interface 204.

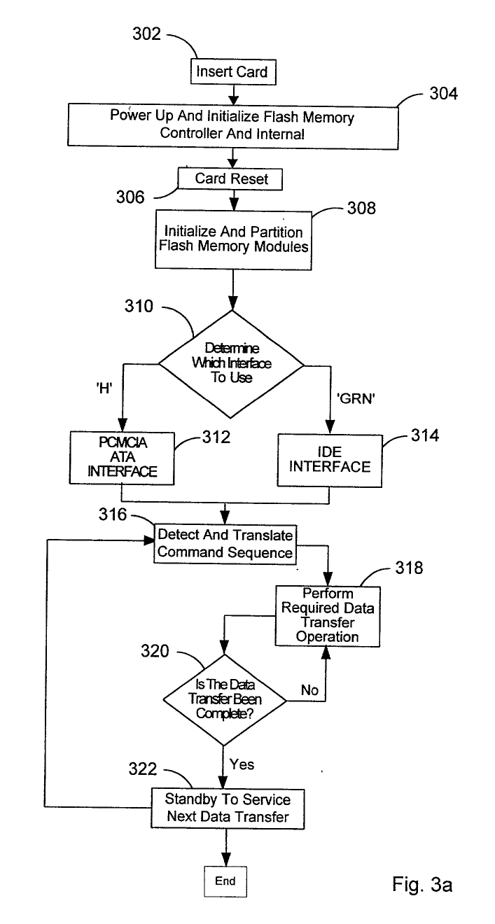

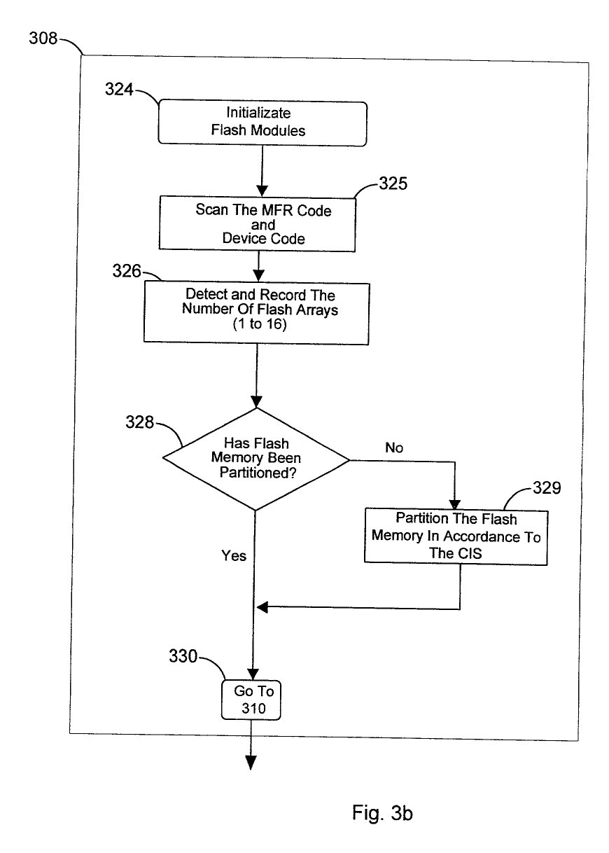

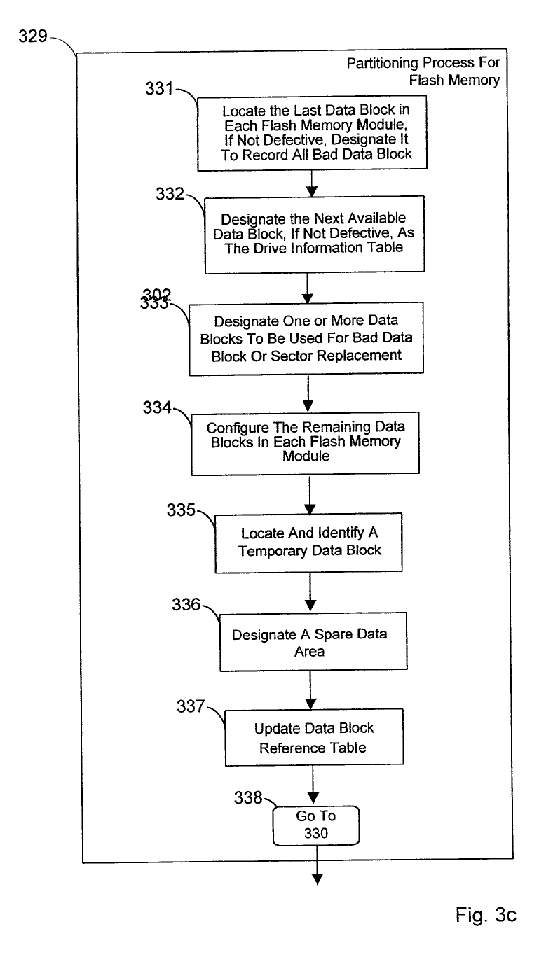

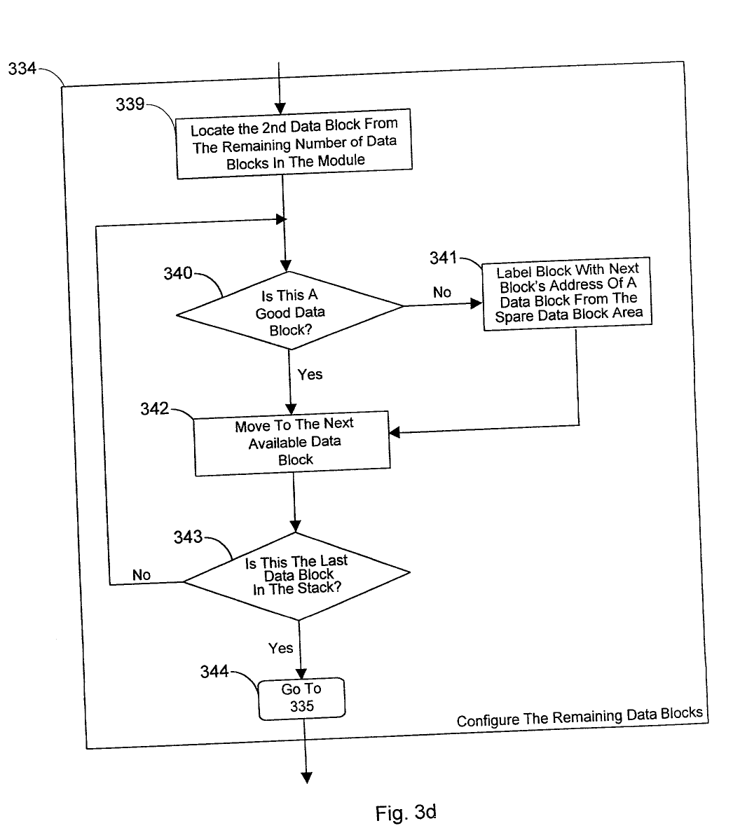

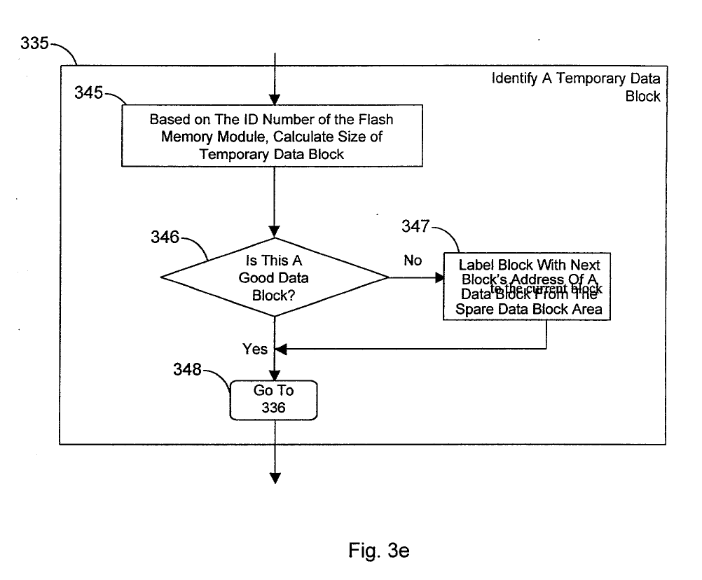

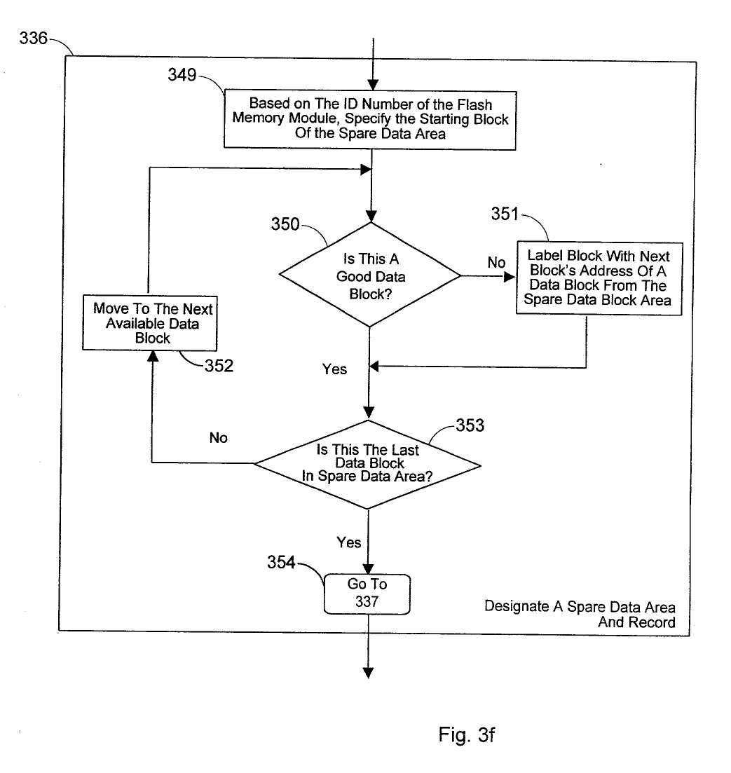

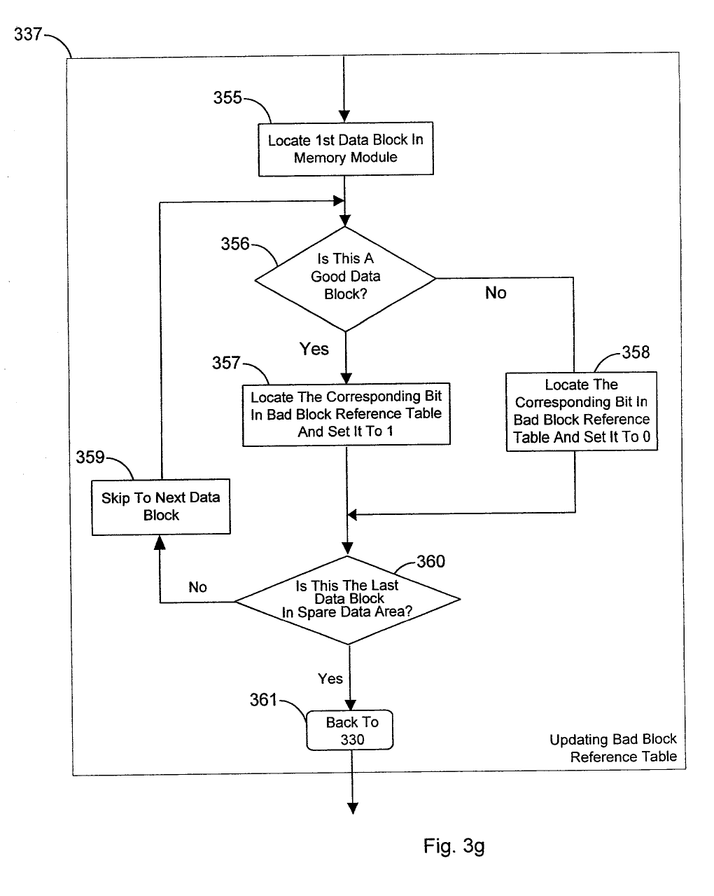

FIG. 3 is a flowchart that illustrates the flow of events performed by the compact flash controller in accordance with FIG. 2. The steps in the flowchart are simply illustrative of the functional steps performed by the by the compact flash controller 200, however, a person of ordinary skill in the art will appreciate that the exact sequence of operation by the compact flash controller 200 to perform the functions described in the flowchart of FIG. 3 may vary. Reference is now to FIG. 3a of flowchart illustrating the steps performed by the compact flash controller to manage data transfers in and out of flash memory 222. As FIG. 3a shows at steps 302, the card is inserted and detected, while at step 304, all components of the card including the compact flash controller 200, are powered up and initialized. At step 308, the flash memory 222, is then initialized and partitioned.

FIG. 3b is a flow chart that further details the steps used by the compact flash controller to initialize and partition the plurality of installed flash memory modules. As FIG. 3b shows, step 308 further includes at step 324 the flash memory module or arrays that are installed on the compact flash memory card inserted into the host device are initialized. In addition, after the manufacture and device codes are detected and scanned, at step 325, compact flash memory controller, at step 326, detects the number of flash memory modules or arrays present on the card. The compact flash memory controller, at step 327, then determines if the flash memory has been partitioned in accordance with the storage requirements of the host device. If the flash memory has been partitioned, the compact flash memory controller, at step 329, continues on to step 310 that determines which interface is to be used. On the other hand, if the flash memory has not been partitioned, the compact flash controller, at step 328, partitions the flash memory in accordance with the configuration information structure (CIS) stored in the read only memory (ROM), together with other software programs. Thus, when a flash memory card is inserted into the card slot of the host device, the host computer searches for the configuration information structure (CIS) of this flash memory card. In the flash memory card, the controller reads the CIS information from the ROM and places it in RAM or a register that the host computer can access. Therefore, in accordance with operative elements of the configuration information structure (CIS), the host computer then assigns memory space, I/O space area, interrupt level and sequential read/write-accesses to the flash memory.

Referring now to FIG. 3c that details the operative elements of step 328 performed by the compact flash controller to configure and partition the plurality of flash memory modules or arrays installed on the installed compact flash memory card. As FIG. 3c shows, the compact flash controller, at step 331, locates the last data block in each flash memory module. If the block is not defective, the controller designates it for use as a bad block reference table. Each bit in the bad block reference table indicates what blocks of the flash memory module or array is either “good or bad”. Then, at step 332, the compact flash controller designates the next available data block, if not defective, to be used as a drive information table. The drive information table maintains all required parameters and information that relate to the complete configuration of the compact flash memory card. In addition, the compact flash controller, at step 333, also designates one or more data blocks to be used for data block and data sector replacement.

FIG. 3c also shows that once the tables and an area for bad block and sector replacement have been selected, the compact flash controller, at step 334 proceeds to configure the remaining data area of each flash memory module or array. Turning now to FIG. 3d that depicts the operative elements of step 334, the compact flash controller at steps 339 and 340, locates and tests the second data block that is below the first or the upper most data block in each flash memory module or array. If the block is defective, the compact flash memory controller, at step 341, labels the defective block with address of a data block from the spare data block area. If the data block is good, the controller, at step 342, moves on to the next available data block in the stack. This process is repeated until all of the remaining blocks have been tested and configured in accordance with the specified configuration information. Upon completion of these elements, the compact flash controller, at step 344, returns to step 335 of the partitioning process to specify a temporary data area.

FIG. 3e shows operative elements of step 335 used to specify a temporary data area. Based on the identification number of each flash memory module, the compact flash controller, at step 345, calculates the size of a temporary data block. The temporary data block is used to temporarily store any data pages that are to be preserved by the host. Thus, the compact flash controller moves these pages into the one or more sectors of the temporary data block prior to executing a block erase. Once the block erase is complete, the compact flash controller then transfers the preserved pages back to the designated data block. At step 346, the compact flash controller determines if the data blocks to be used for a temporary data area are defective or not. If the block is defective, the compact flash memory controller, at step 347, labels the defective block with address of a data block from the spare data block area and then moves on to the next available data block in the stack. On the other hand, if the data block is determined is not defective, the controller, at step 348, returns to step 336 of the partitioning process that designates a spare data area.

Referring now to FIG. 3f that details the operative elements of step 336. As FIG. 3f shows based on the identification number of each flash memory module, the compact flash controller, at step 349, identifies the starting data block of the spare data area. If the block is defective, the compact flash memory controller, at step 351, labels the defective block with address of a data block from the spare data block area. Then at step 353, the compact flash controller determines if the data block just checked is the last block in the spare data area. If the data block is not, the controller, at step 352, continues on to the next available data block. This process is repeated until all of the blocks in the spare data area have been configured. If it is determined that it is the last block, the compact flash controller, at step 354, returns to step 337 of the partitioning process that updates the bad data block reference table.

FIG. 3g shows the operative elements of step 337 performed by compact flash controller to update the bad data block reference table. As FIG. 3g shows, the compact flash controller, at step 355, locates and tests the first data block in the flash memory module or array. If the block is defective, the compact flash controller, at step 358, locates the corresponding bit in the reference table and set the bit to zero (0). If the block is good, the compact flash controller, at step 357, locates the corresponding bit in the reference table and set the bit to one (1). The compact flash controller, at step 360, determines if the data block just checked is the last data block. If the data block is not, the controller, at step 359, continues to the next available data block. This process is repeated until all of the blocks have been tested and the reference table has been updated. Once these elements have been completed, the compact flash controller, at step 361, returns to step 330 that, in turn returns, to step 310 that determines which interface specification to use.

At step 310, the compact flash controller determines which interface is to be used by detecting whether the OE/ATSEL is high (H) or at ground (L or GRD). If the received OE/ATSEL signal is high (H), the PCMCIA-ATA interface specification is selected. On the other hand, if the OE/ATSEL, at step 310 is low (L) or at ground (GND) then, at step 314, the IDE interface is selected. Once the interface has been selected, the compact flash controller, at step 316, detects and translates a “command in” signal to the appropriate operative sequence that relates to that command. The compact flash controller, at step 318, performs the required data transfer operation in accordance with the translated command sequence received from the host or external device. This process is repeated, at step 320, until the specified data transfer is complete. Once the data transfer is done, the compact flash controller, at step 322, go into stand by mode waiting for the next data transfer. If either the software reset or a new “command in” signal does not occur in a predetermined time period, the controller, in step 322, goes to sleep.

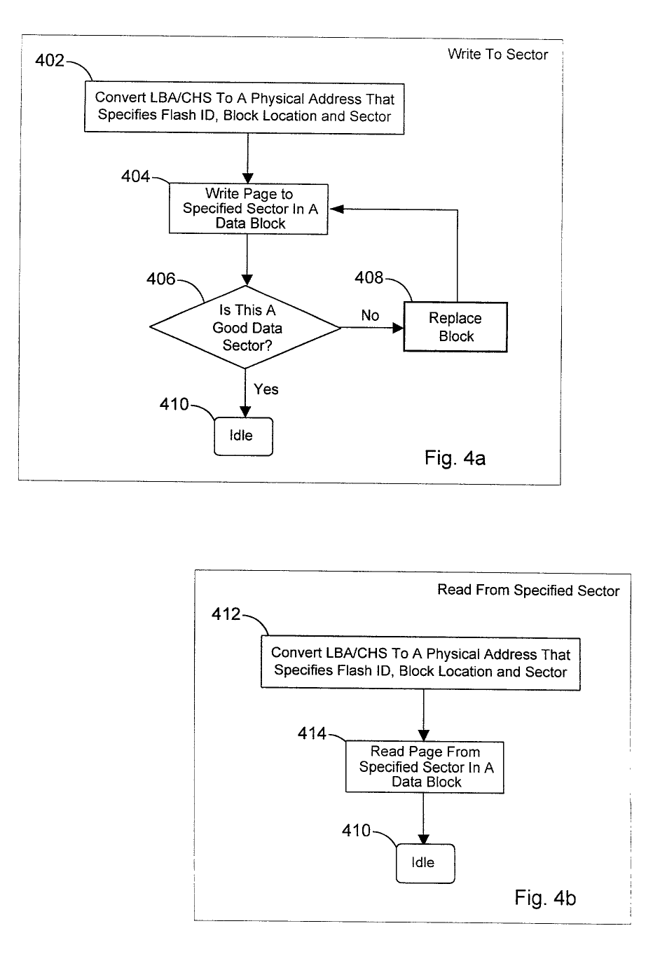

FIGS. 4a an 4b is a detailed flow of event preformed by the compact flash controller to execute the fundamental commands of transferring data or applications content in or out of flash memory. As shown 4a, at step 402, the compact flash controller converts the LBA/CHS to a physical address that specifies the identification number of the flash module or array, the block location and sector numbers where a page of data is to be written. The compact flash controller, at step 404, then writes a data page into the specified data sector. If, at step 406, the block or data sector is bad, the compact flash controller, at step 408, substitutes the defective data block with a data block designated to replace a defective data block or sector. If the write to sector operation is successful, the controller, at step 410 and more specifically, at step 320, (shown in FIG. 3a), is ready to execute the next “command in” received for the host device.

When a read from sector operation is specified, the compact flash controller, at step 412, converts the LBA/CHS to a physical address that specifies the identification number of the flash module or array, the block location and sector numbers of the data page to be read. The compact flash controller, at step 414, then reads a data page from the specified data sector. When the read sector operation is complete, the controller, at step 410 and more specifically, at step 320, (shown in FIG. 3a), is ready to execute the next “command in” received for the host device.

While the foregoing detailed description has described several embodiments of the compact flash controller in accordance with this invention, it is to be understood that the above description is illustrative only and not limiting of the disclosed invention. Particularly, used in a compact flash memory card, the compact flash controller automatically detects which operational mode is used for the attached interface device and configures the memory card to perform the necessary data transfers in accordance with that operation mode. Thus, the compact flash controller allows the memory card to operate in either the PCMCIA mode, or the ATE IDE mode. These operating modes are merely exemplary. The compact flash controller can be configured to automatically detect and operate in additional operating modes and with additional interfaces. It will be appreciated that the embodiments discussed above and the virtually infinite embodiments that are not mentioned could easily be within the scope and spirit of this invention. Therefore, the invention is to be limited only by the claims as set forth below.

What is claimed is:

1. A method of carrying out a data transfer to and from a flash memory array performed by a compact flash controller comprising the steps of:
inserting and powering up a compact flash memory device containing a plurality of compact flash memory arrays;
detecting presence of a plurality of compact flash memory arrays wherein the compact flash controller detects the number of compact flash memory arrays that comprise the compact flash memory device;
initializing controller, a plurality of flash memory modules as well as other internal components;
partitioning each of the flash memory arrays in accordance to the parameters of the configuration information table stored in a read-only memory of the compact flash controller;
determining which interface specification is to be used for to transfer data, address information and control signals to and from the host device;
detecting a command sequence to be processed;
translating the specified command sequence into a set of data transfer operative elements; and
executing the specified data transfer.

2. The method as recited in claim 1, wherein if the state of received signal is high then a PCMCIA/ATA interface is selected to receive and transfer data, address information between flash memory and a host device.

3. The method as recited in claim 1, wherein if the state of received signal is low then a true IDE interface is selected to receive as well as transfer of data, address information between flash memory and a host device.

4. The method as recited in claim 1, wherein the set of data transfer operative elements that has been translated from the specified command sequence directs the compact flash controller to writes data and address content received from the host device to at least one sector of a flash memory array.

5. The method as recited in claim 1, wherein the set of data transfer operative elements that has been translated from the specified command sequence directs the compact flash controller to reads data and address content from at least one sector of a flash memory array.

6. The method as recited in claim 1, wherein the compact flash controller continues to perform each of the data transfer operative elements until a data transfer is complete.

7. The method as recited in claim 1, wherein the compact flash controller stands by waiting a predetermined time period for the next data transfer operation.

8. The method as recited in claim 7, wherein after if the a predetermined time period elapses, the compact flash controller suspends any operative activity and waits until a request to execute a new command sequence is detected.

9. A system for controlling the transfer of data between flash memory and a host device comprising:
circuitry of the compact flash controller configured to insert and power up a compact flash memory device containing a plurality of compact flash memory arrays;
circuitry of the compact flash controller configured to detect presence of a plurality of compact flash memory arrays wherein the compact flash controller detects the number of compact flash memory arrays that comprise the compact flash memory device;
circuitry of the compact flash controller configured to initialize controller, a plurality of flash memory modules as well as other internal components;
circuitry of the compact flash controller configured to partition each of the flash memory arrays in accordance to the parameters of the configuration information table stored in a read-only memory of the compact flash controller;
circuitry of the compact flash controller configured to determine which interface specification is to be used for to transfer data, address information and control signals to and from the host device;
circuitry of the compact flash controller configured to detect a command sequence to be processed;
circuitry of the compact flash controller configured to translate the specified command sequence into a set of data transfer operative elements; and
circuitry of the compact flash controller configured to execute the specified data transfer.

10. The system as recited in claim 9, wherein the circuitry of the compact flash controller initiates PCMCIA/ATA interface is selected to receive as well as transfer of data, address information between flash memory and a host device, if the state of the received signal is high.

11. The apparatus as recited in claim 9, wherein the circuitry of the compact flash controller initiates IDE interface is selected to receive as well as transfer of data, address information between flash memory and a host device, if the state of the received signal is low.

12. The apparatus as recited in claim 9, wherein the circuitry of the compact flash controller initiates a write to at least one data sector of a flash memory array of data and address content received from the host device, if the the set of data transfer operative elements translated from the command sequence command specifies such an operation.

13. The apparatus as recited in claim 9, wherein the circuitry of the compact flash controller initiates a read from at least one data sector of a flash memory array of the stored data and address content, if the set of data transfer operative elements translated from the command sequence specifies such an operation.

14. The apparatus as recited in claim 9, wherein the circuitry of the compact flash controller continues to perform each of the data transfer operative elements until the data transfer is complete.

15. The apparatus as recited in claim 9, wherein the circuitry of the compact flash controller stands by waiting a predetermined time period for the next data transfer operation.

16. The apparatus as recited in claim 15, wherein the circuitry of the compact flash controller suspends any operative activity and waits until a request to execute a new command sequence to be detected, if the a predetermined time period elapses.

17. A computer program product that includes a computer useable medium having computer readable code embodied therein controlling the transfer of data between flash memory and a host device, the computer program product comprising:
a computer readable program code devices of the compact flash controller configured to insert and power up a compact flash memory device containing a plurality of compact flash memory arrays;
a computer readable program code devices of the compact flash controller configured to detect presence of a plurality of compact flash memory arrays wherein the compact flash controller detects the number of compact flash memory arrays that comprise the compact flash memory device;
a computer readable program code devices of the compact flash controller configured to initialize controller, a plurality of flash memory modules as well as other internal components;
a computer readable program code devices of the compact flash controller configured to partition each of the flash memory arrays in accordance to the parameters of the configuration information table stored in a read-only memory of the compact flash controller;
a computer readable program code devices of the compact flash controller configured to determine which interface specification is to be used for to transfer data, address information and control signals to and from the host device;
a computer readable program code devices of the compact flash controller configured to detect a command sequence to be processed;
a computer readable program code devices of the compact flash controller configured to translate the specified command sequence into a set of data transfer operative elements; and
a computer readable program code devices of the compact flash controller configured to execute the specified data transfer.

18. The computer program product as recited in claim 17, wherein if the state of the received signal is high then the computer readable program code devices of the compact flash controller initiates a PCMCIA/ATA interface is selected to receive as well as transfer of data, address information between flash memory and a host device.

19. The computer program product as recited in claim 17, wherein if the state of the received signal is low then the computer readable program code devices of the compact flash controller initiates a true IDE interface is selected to receive as well as transfer of data, address information between flash memory and a host device.

20. The computer program product as recited in claim 17, wherein the computer readable program code devices of the compact flash controller writes to at least one sector of a compact flash memory array, data and address content received from the host device.

21. The computer program product as recited in claim 17, the computer readable program code devices of the compact flash controller reads from at least one sector of a compact flash memory array data and address content that is transferred back to the host device.

22. The apparatus as recited in claim 9, the computer readable program code devices of the compact flash controller continues to perform each of the data transfer operative elements until the data transfer is complete.

23. The computer program product as recited in claim 17, the computer readable program code devices of the compact flash controller stands by waiting a predetermined time period for the next data transfer operation.

24. The computer program product as recited in claim 23, the computer readable program code devices of the compact flash controller suspends any operative activity and waits until a request to execute a new command sequence to be detected, if the a predetermined time period elapses.
